(19) United States
(12) Patent Application Publication
(10) Pub. No.: US 2023/0336687 A1
(43) Pub. Date: Oct. 19, 2023

(54) SEPARATE AND SIMULTANEOUS REAL-TIME VIDEO AND REAL-TIME DATA CONNECTIONS BETWEEN REMOTELY LOCATED COMPUTERS FOR ORDERING AND PAYMENT

(71) Applicant: The Yellow Lab Agency, LLC, Dallas, TX (US)

(72) Inventor: Jeffrey Paul Sinelli, Dallas, TX (US)

(21) Appl. No.: 18/300,998

(22) Filed: Apr. 14, 2023

Related U.S. Application Data
(60) Provisional application No. 63/363,092, filed on Apr. 15, 2022.

(51) Int. Cl. H04N 7/14; G06Q 20/10; G06Q 20/18; G06Q 20/38; G06Q 20/42

(52) U.S. Cl. CPC H04N 7/141; G06Q 20/108; G06Q 20/18; G06Q 20/389; G06Q 20/42

(57) ABSTRACT

Separate and simultaneous real-time video and real-time data connections between remotely locate computers are used for ordering and payment. The real-time video connection can be a two-way video stream, and the real-time data connection can be a one-way data connection. The connections are used to build an order, process payment, and fulfill the order while the computers connected to the connections are remotely located from one another.

### CROSS-REFERENCE TO RELATED APPLICATIONS

This application is a non-provisional patent application of and claims priority to U.S. Provisional Patent Application No. 63/363,092, filed on Apr. 15, 2022, and entitled “Contactless Ordering and Payment with Virtual Customer Service Agent”, the disclosure of which is hereby incorporated herein by reference as if reproduced in its entirety.

### FIELD OF THE DISCLOSURE

The present disclosure generally relates to ordering and payment at a point of sale that involves a contactless human-to-human interaction between the customer and a customer service agent. More particularly, the disclosure relates to separate and simultaneous real-time video and real-time data connections between remotely located computers for ordering and payment.

### BACKGROUND

The COVID-19 pandemic greatly affected how customers order goods and services at merchant brick and mortar locations. Some merchant brick and mortar locations closed to customers, leaving customers to order goods and services only through online e-commerce platforms, or not at all. In some cases where brick and mortar locations stayed open to customers, customers would stand at a point of sale in a merchant's store, with the customer service agent wearing a mask, the customer wearing a mask, and a sheet of plastic glass between the customer and agent. In these instances, orders would be incorrectly heard by the customer service agent, resulting in longer ordering time for the customer to clarify wrong orders, or resulting in the customer receiving the wrong goods or services from the ordering interaction.

One solution provided by merchants was to have self-service ordering computers at brick and mortar locations, where the customer service agent was removed from the interaction, and the customer could interact on-location with an ordering computer, for example, via a touchscreen display, to build an order and pay for the order. This solution lead to a customer interaction devoid of human-to-human interaction, which can devalue a merchant's customer interaction experience.

There is a need for contactless ordering that involves human-to-human interaction between the customer and customer service agent.

### SUMMARY

Disclosed herein are systems and methods for contactless ordering and payment that utilize separate and simultaneous real-time video and real-time data connections between remotely located computers.

In some aspects, the techniques described herein relate to a method including: receiving, by a service computer from an order computer, a real-time connection request; and in response to receiving the real-time connection request, connecting, by the service computer and the order computer, for an order session, wherein connecting includes: joining, by the service computer, a real-time two-way video stream between a video conferencing module of the order computer and a video conferencing module of the service computer, and joining, by the service computer, a real-time one-way data connection between an order module of the order computer and an order module of the service computer, wherein the service computer and the order computer are connected to the real-time two-way video stream and the real-time one-way data connection simultaneously.

In some aspects, the techniques described herein relate to a service computer having a processor, a memory, and instructions stored on the memory that are configured to be executed by the processor to cause the service computer to: receive, from an order computer, a real-time connection request; and in response to receiving the real-time connection request, connect with the order computer for an order session, wherein connect includes: join a real-time two-way video stream between a video conferencing module of the order computer and a video conferencing module of the service computer, and join a real-time one-way data connection between an order module of the order computer and an order module of the service computer, wherein the service computer and the order computer are connected to the real-time two-way video stream and the real-time one-way data connection simultaneously.

In some aspects, the techniques described herein relate to a method including: sending, by an order computer to a service computer, a real-time connection request; and in response to sending the real-time connection request, connecting, by the service computer and the order computer, for an order session, wherein connecting includes: joining, by the order computer, a real-time two-way video stream between a video conferencing module of the order computer and a video conferencing module of the service computer, and joining, by the order computer, a real-time one-way data connection between an order module of the order computer and an order module of the service computer, wherein the service computer and the order computer are connected to the real-time two-way video stream and the real-time one-way data connection simultaneously.

In some aspects, the techniques described herein relate to an order computer having a processor, a memory, and instructions stored on the memory that are configured to be executed by the processor to cause the order computer to: send to a service computer a real-time connection request; and in response to send the real-time connection request, connect, by the service computer and the order computer, for an order session, wherein connect includes: join, by the order computer, a real-time two-way video stream between a video conferencing module of the order computer and a video conferencing module of the service computer, and join, by the order computer, a real-time one-way data connection between an order module of the order computer and an order module of the service computer, wherein the service computer and the order computer are connected to the real-time two-way video stream and the real-time one-way data connection simultaneously.

In some aspects, the techniques described herein relate to a service and order computer system comprising: one or more services computers capable of being networked with one or more order computers, wherein each of the service computers has a video conferencing module and an order module that are capable of, upon request from any of the order computers, connecting with a video conference module and an order module of the respective order computer, wherein connecting includes joining, by a service computer/order computer pair, a real-time two-way video stream between a video conferencing module of the order computer and a video conferencing module of the service computer, and joining, by the service computer/order computer pair, a real-time one-way data connection between an order module of the order computer and an order module of the service computer, wherein the service computer/order computer pair are connected to the real-time two-way video stream and the real-time one-way data connection simultaneously. The one or more service computers can each independently be embodied according to any embodiment described herein. The one or more order computers can each independently be embodied according to any embodiment described herein. The system can also include a video surveillance system configured to record and/or a video of the order computer and area for a customer ordering at the order computer to a server for video surveillance. The system can also include one or more fulfillment computers networked with the one or more order computers, wherein each fulfillment computer is configured to receive an order from the respective order computer after order competition using the connections between the service computer/order computer pair.

Other technical features may be readily apparent to one skilled in the art from the following figures, descriptions and claims.

### BRIEF DESCRIPTION OF THE DRAWINGS

For a more complete understanding of this disclosure, reference is now made to the following description, taken in conjunction with the accompanying drawings, in which:

FIG. 1 illustrates a schematic diagram of an embodiment of a contactless ordering and payment computer system.

FIG. 2 illustrates a schematic diagram of data flow among components of the system of FIG. 1.

FIG. 3 illustrates a schematic diagram of another embodiment of a contactless ordering and payment computer system.

FIG. 4 illustrates a schematic diagram of another embodiment of a contactless ordering and payment computer system.

FIGS. 5A to 5G illustrate various perspective views of an order computer embodied as a kiosk.

FIG. 6 illustrates a perspective view of a service computer.

### DETAILED DESCRIPTION

“Application program” or “application” or “app” as used herein refers to instructions stored on and/or running on a computer, which when executed by a processor of the computer, causes the computer to perform a function(s) of the application disclosed herein.

“Order computer” as used herein refers to kiosk, a mobile phone (e.g., smartphone), a tablet, a laptop, a desktop, or other computer device configured to have computer hardware and software and/or apps running thereon by which a customer can conduct a video session with a service computer, enter or confirm customer payment information for transmission to a payment processing computer, and any other function described herein.

“Service computer” as used herein refers to a mobile phone (e.g., smartphone), a tablet, a laptop, a desktop, or other computer device configured to have computer hardware and software and/or apps running thereon by which a customer service agent can conduct a video session with an order computer, build an order for transmission to a fulfillment computer, and any other function described herein.

“Two-way” when used to refer to a connection between two computers for data transfer such as a video connection between two computers, means that first computer video data is transferred from the first computer to the second computer and second computer video data is transferred from the second computer to the first computer.

“One-way” when used to refer to a connection between two computers for data transfer such as order building, means that first computer data is transferred from the first computer to the second computer and there is no second computer data that is transferred from the second computer to the first computer.

“Real-time” as used herein with respect to a connection between computers and temporal relationships means a live connection and performance. The connection and performance timing can include lags associated with processing power and network data transfer. Real-time as used herein include near real-time where delays in transmitting data from one computer to another are due to the lags discussed herein.

“Simultaneous” as used herein refers to the connection occurring at the same time. “Simultaneous” connections include those that initiate and/or end at the same instant of time and those that have different instances of time for initiation and/or ending.

Disclosed herein is a computer system and method for contactless ordering and payment that utilize separate and simultaneous real-time video and real-time data connections between remotely located computers. In the computer system and method, the customer service agent remotely located relative to the customer. Ordering is completed by connecting a service computer with an order computer so that the customer and a customer service agent can interact to build an order, collect customer payment information, confirm payment, and fulfill the order. Downtime of a customer service agent waiting for customers can be reduced because a customer service agent in a first geographic location can take orders from customers in any other geographic location.

For example, a customer service agent can field lunch orders via a service computer for the US eastern time zone during the lunch rush in the US eastern time zone, followed by lunch orders for the US central time zone during lunch rush in the US central time zone, followed by lunch order for the US mountain time zone during lunch rush in the US mountain time zone, followed by lunch rush for the US pacific time zone during lunch rush in the US pacific time zone. The disclosed system and method increase the customer throughput of a customer service agent by decentralizing the customer service agent's location from the location of the customer and from the location of the merchant store. The computer system can be utilized for ordering food, clothing, products, pharmaceuticals, and other medicine.

The figures may be described below with reference to computer hardware components that may form part of a computer system; however, it should be understood that any combination of the functionality of the hardware components may form at least part of a method as disclosed herein.

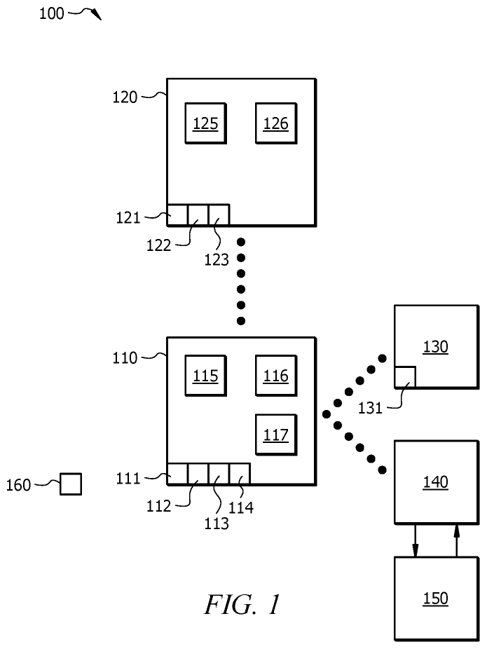

FIG. 1 illustrates a schematic diagram of an embodiment of a contactless ordering and payment computer system 100. The system 100 can include an order computer 110, a service computer 120, a fulfillment computer 130, a payment processing computer 140, and a video surveillance system 160. The order computer 110, service computer 120, fulfillment computer 130, and video surveillance system 160 are administered by a merchant. The payment processing computer 140 is administered by a third-party payment processing service provider, such as Toast, Inc., Block, Inc. (formerly Square, Inc.), Oracle (formerly Micros Systems, Inc.), or Coinbase.

The order computer 110 can be embodied as one or more computers. Each computer of the order computer 110 can include one or more processors, memory, networking cards or interfaces, and other equipment for performing the method and functionality disclosed herein. The order computer 110 illustrated in FIG. 1 can be embodied as a kiosk, a smartphone, or any other computer device that is within the scope of a service computer as disclosed herein. In embodiments, the order computer 110 can have a display 111, a video camera 112, and a microphone and speaker 113. In additional embodiments, the order computer 110 can have a sensor 114 configured to detect presence of a customer at or in the vicinity of the service computer 120.

The display 111 can include one or more screens configured to display images, such as LCD screens, OLED screens, or other computer screens. In embodiments, the display 111 can include one or more touchscreens by which the customer can enter input (e.g., order information, payment information) into the order computer 110.

The video camera 112 can be embodied as any video camera configured to digital the image of a person for communication of the image to the service computer 120.

The microphone and speaker 113 can include any audio microphone configured to sense acoustic waves, convert the acoustic waves to a digital signal, and to send the digital signal to the service computer 120. The acoustic waves sensed by the audio microphone can have frequencies within the range of the human voice, frequencies greater than the human voice, frequencies less than the human voice, or combinations thereof. The microphone and speaker 113 can further include any audio speaker configured to receive a digital signal from the service computer 120, convert the signal to acoustic waves, and to emit the acoustic waves in proximity to the customer that is present at or near the order computer 110.

The sensor 114 can include a temperature sensor, a pressure sensor, a light sensor, a motion sensor, or combinations thereof. The order computer 110 can have software or applications thereon that include a video conferencing module 115, an order module 116, and a payment module 117.

The service computer 120 can be embodied as one more computers. Each computer of the service computer 120 can include one or more processors, memory, networking cards or interfaces, and other equipment for performing the method and functionality disclosed herein. In embodiments, the service computer 120 can be include multiple computers, located in a brick-and-mortar location, local to the administrator of the service computer 120, in the cloud, or a combination thereof. The service computer 120 illustrated in FIG. 1 can be embodied as a smartphone, or any other computer device that is within the scope of service computer as disclosed herein. In embodiments, the service computer 120 can have a display 121, a video camera 122, and a microphone and speaker 123. The service computer 120 can have software or applications thereon that include a video conferencing module 125 and an order module 126.

The display 121 can include one or more screens configured to display images, such as LCD screens, OLED screens, or other computer screens. In embodiments, the display 121 can include one or more touchscreens by which the customer service agent can enter input (e.g., order information) into the service computer 120.

The video camera 122 can be embodied as any video camera configured to digital the image of a person for communication of the image to the order computer 110.

The microphone and speaker 123 can include any audio microphone configured to sense acoustic waves, convert the acoustic waves to a digital signal, and to send the digital signal to the order computer 110. The acoustic waves sensed by the audio microphone can have frequencies within the range of the human voice. The microphone and speaker 123 can further include any audio speaker configured to receive a digital signal from the order computer 110, convert the signal to acoustic waves, and to emit the acoustic waves in proximity to the customer service agent that is present at or near the service computer 120.

The fulfillment computer 130 can include one or more processors, memory, networking cards or interfaces, and other equipment for performing the method and functionality disclosed herein. The fulfillment computer 130 can be embodied as any computer device configured to receive an order from the order computer 110 and having a display 131 for displaying the order to personnel that fulfill the order. Additionally or alternatively, the fulfillment computer 130 can have a printer to print the order on a piece of paper. In aspects, the fulfillment computer 130 can be a computer located in a kitchen of a restaurant that displays or prints food orders to cooks or located in a pharmacy that displays or prints pharmaceutical orders to a pharmacist.

The payment processing computer 140 can be embodied as one or more computer devices configured to receive customer payment information and process the payment via payment entities payment systems 150. The payment processing computer 140 can be administered by a third-party payment processing provider at locations different than the location of the service computer 120 and different than the location of the order computer 110. The payment entities payment systems 150 are generally associated with the payment card/account of the customer that is associated with the payment information processed by the system 100. The payment entities payment systems 150 are generally third parties located offsite and are typical entities having equipment and payment networks for processing payment transactions (e.g., computer equipment of an acquiring bank, issuing bank, processing entity, a VISA® payment processing network, for example).

The video surveillance system 160 can include one or more video cameras, wiring, networking, processors, and memory that cause the video surveillance system 160 to record or otherwise transmit images (video, photo, or both) of the location of the order computer 110 for data processing. The video surveillance system 160 can be networked with the service computer 120 to transmit image data, or data derived from image analysis to the service computer 120.

Regarding network communication technology, the order computer 110 can be networked with the service computer 120. The service computer 120 can additionally be networked with the video surveillance system 160. The order computer 110 can additionally be networked with the fulfillment computer 130 and with the payment processing computer 140. The payment processing computer 140 can additionally be networked with payment entities payment systems 150.

Networking between any two computers and/or devices in the system 100 can be via any wired internet connection, wireless internet connection, local area network (LAN), wired intranet connection, wireless intranet connection, or combinations thereof. The networking used for communication can include a Global System for Mobile Communications (GSM), Code-division multiple access (CDMA), General Packet Radio Service (GPRS), Evolution-Data Optimized (EV-DO), Enhanced Data Rates for GSM Evolution (EDGE), Universal Mobile Telecommunications System (UMTS), etc.

While the order computer 110 and the service computer 120 are administered by a merchant, the geographic location of the order computer 110 is different than the geographic location of the service computer 120. For example, the order computer 110 can be embodied as a kiosk in a merchant restaurant or pharmacy brick-and-mortar location, while the service computer 120 can be embodied as a computer device located in another brick-and-mortar location; alternatively, the order computer 110 can be embodied as a customer's smartphone that is at a first geographic location (e.g., the customer's home) and the service computer 120 can be embodied as a computer device located in a second geographic location (e.g., one of the merchant's administration locations); alternatively, the order computer 110 can be embodied as a customer's smartphone that is at a first geographic location (e.g., the customer's home) and the service computer 120 can be embodied as a customer service agent's smartphone located in a second geographic location (e.g., the customer service agent's home).

In some embodiments, such as those where the order computer 110 is embodied as a kiosk, the geographic location of the fulfillment computer 130 is the same as (e.g., in the same brick-and-mortar merchant store) the geographic location of the order computer 110; alternatively, in other embodiments the geographic location of the fulfillment computer 130 is different than the geographic location of the order computer 110, such as in embodiments where the order computer 110 is embodied as a smartphone. In embodiments where the fulfillment computer 130 and the order computer 110 are in the same geographic location, at least one video camera of the video surveillance system 160 can be in the same geographic location as the fulfillment computer 130 and the order computer 110.

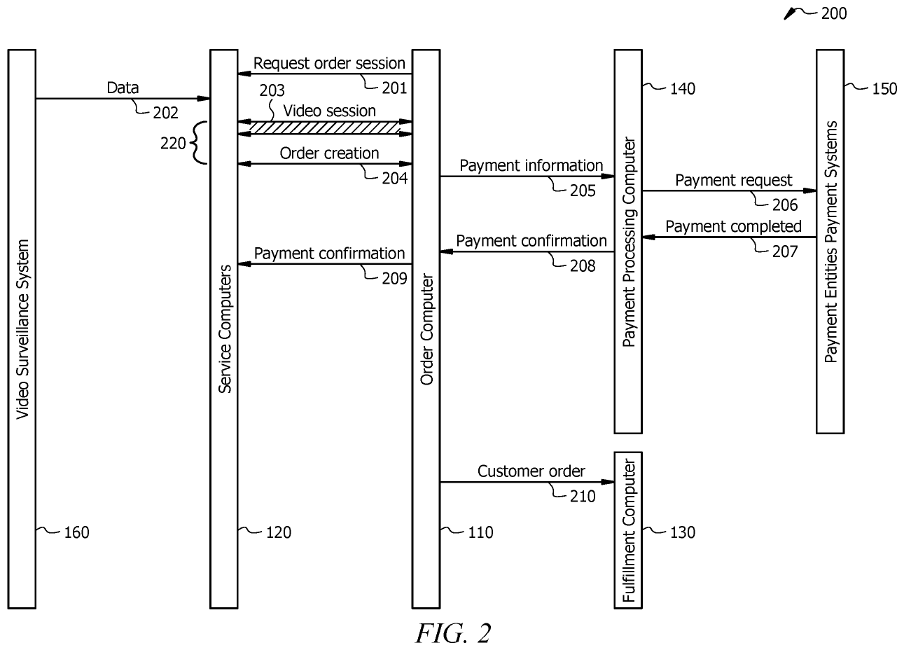

FIG. 2 illustrates a schematic diagram of data flow among components 110, 120, 130, 140, 150, and 160 of the system 100 of FIG. 1. The data flow illustrates a sequence of steps, one or more of which can define a process 200 disclosed. The flow of data begins at the top of FIG. 2 and ends at the bottom of FIG. 2.

In the process 200, a customer ordering session can be initiated by the order computer 110. In embodiments where the order computer 110 is a customer's smartphone, the customer can select a button on a merchant's ordering app running on the customers smartphone, and the app can cause the customer's smartphone to send a request order session message 201 to the service computer 120. The service computer 120 can receive the request order session message 201.

In embodiments where the order computer 110 is a computer or kiosk that has a sensor 114 integrated into or proximate the kiosk, the sensor 114 can sense a presence of the customer (e.g., via temperature, pressure, light, motion, or combinations thereof) by generating a signal that can be interpreted by the order computer 110 as being indicative of the customer presence. The order computer 110 can send the request order session message 201 to the service computer 120. The service computer 120 can receive the request order session message 201.

After receiving the request order session message 201 from the order computer 110, the service computer 120 and the order computer 110 can be configured to connect for an order session 220 that includes two components: a video session 203 and order creation 204. The computers 110 and 120 connect for the order session 220 by 1) joining a real-time video stream between the video conferencing module 115 of the order computer 110 and the video conferencing module 125 of the service computer 120, and 2) joining a real-time data connection between the order module 116 of the order computer 110 and the order module 126 of the service computer 120. In aspects, the video stream is a two-way video stream. In aspects, the data connection is a one-way data connection for transmission of data only from the service computer 120 to the order computer 110; alternatively, the data connection is a two-way data connection for transmission of data between computers 110 and 120.

Generally, in the order session 220, at least part of the real-time two-way video stream is synchronous with (overlaps with) at least part of the real-time data connection. Having the real-time two-way video stream the real-time data connection synchronous in the order session 220 allows for the customer service agent to remotely interact with the customer via the real-time two-way video stream and to enter the customer's order into the order module 126 of the service computer 120 while the customer is present at the order computer 110.

In aspects, the order computer 110 and the service computer 120 are connected for the real-time two-way video stream and for the real-time data connection simultaneously for substantially all (e.g., >99% of the duration of the order session 220) of the order session 220; alternatively, the order computer 110 and the service computer 120 are connected for the real-time two-way video stream for a duration of time that is greater than the duration of time that the order computer 110 and the service computer 120 are connected for the for the real-time data connection; alternatively, the order computer 110 and the service computer 120 are connected for the real-time two-way video stream for a duration of time that is less than the duration of time that the order computer 110 and the service computer 120 are connected for the for the real-time data connection.

In aspects, the real-time two-way video stream can be initiated by the video conferencing module 115 of the order computer 110 or the video conferencing module 125 of the service computer 120.

In aspects, the real-time data connection can be initiated by the order module 116 of the order computer 110 or the order module 126 of the service computer 120.

In aspects, the video conferencing module 115 of the order computer 110 and the video conferencing module 125 of the service computer 120 can be embodied as accounts of a video conferencing service that are accessible via a web browser or app running on each of the order computer 110 and the service computer 120. Both the order computer 110 and the service computer 120 can have accounts that are accessible via a login portal displayed on each computer 110 and 120 for the video conferencing service, and the video conferencing service can provide the real-time two-way video stream between the order computer 110 and the service computer 120. In embodiments, the video conferencing service is a cloud-based video conferencing service.

In aspects, the order module 116 of the order computer 110 and the order module 126 of the service computer 120 can be embodied as accounts of an ordering service that are accessible via a web browser or app running on each of the order computer 110 and the service computer 120. Both the order computer 110 and the service computer 120 can have accounts that are accessible via a login portal displayed on each computer 110 and 120 for the ordering service, and the ordering service can provide the real-time data connection between the order computer 110 and the service computer 120. In embodiments, the ordering service is a cloud-based ordering service.

In embodiments where accounts are accessible via an app running on the order computer 110 and/or the service computer 120, the app that provides access to the video conferencing service can be the same app that provides access to the ordering service—the video conferencing service and ordering service can be integrated into the same program or app that is accessible or running on the order computer 110 and service computer 120. Alternatively, the app that provides access to the video conferencing service can be separate from the app that provides access to the ordering service—the video conferencing service and ordering service are separate programs or applications accessible or running on the order computer 110 and service computer 120.

The video conferencing module 115 running on the order computer 110 and the video conferencing module 125 running on the service computer 120, the video conferencing service, or combinations thereof can utilize video streaming technology and architecture to provide the real-time video session 203. In embodiments, the system 100 can utilize multimedia routing or decentralized video conferencing by which the computer system 100 (or system 300 or system 400 described below) can match the order computer 110 with the service computer 120, and the video conferencing module 115 of the order computer 110 can connect directly with the video conferencing module 125 of the service computer 120 via one or more networks disclosed herein, for a live real-time video session 203 between the computers 110 and 120. Alternatively, system 100 can utilize a multipoint control unit (MCU) by which the MCU can receive and present the video streams from and to the video conferencing module 115 of the order computer 110 and from and to the video conferencing module 125 of the service computer 120.

During the video session 203, the customer and customer service agent can interact, and the customer service agent, in order creation 204, can input and build the order for the customer via the order module 126 on the service computer 120. The order built during order creation 204 can be transmitted by the service computer 120 to the order computer 110 for display on the order computer 110. Because of the real-time data connection, the order can be displayed on a display of the order computer 110 in real-time for viewing by a customer viewing a display of the order computer 110. The order is not part of the video session 203 and is part of the order creation 204, as such, transmission of the order is via the real-time data connection and not via the real-time two-way video stream. In aspects, the real-time data connection is one way for real-time transmission of an order from the service computer 120 to the order computer 110 for display on the order computer 110. In aspects, after order creation 204 is complete, the service computer 120 can send a build completion message to the order computer 110 via the real-time data connection.

After order creation 204 is complete, the order computer 110 (e.g. via a payment module 117) can display a prompt to the customer for input of payment information at the order computer 110. In aspects, displaying the prompt can be in response to the order computer 110 receiving the build completion message from the service computer 120. In some embodiments, such as a kiosk embodiment, the order computer 110 can include a card scanner, a card reader, a code (e.g., QR code or barcode) reader, or other device configured to receive payment information from the customer at the order computer 110. In other embodiments, such as the smartphone embodiment, the payment module 117 of the order computer 110 can already include a payment information or link to payment app previously set up by the customer, that can be used for customer payment. The customer can provide payment information via the payment module 117 of the order computer 110. The payment module 117 of the order computer 110 can be configured to send a payment information message 205 to the payment processing computer 140.

The payment processing computer 140 can analyze the customer payment information received in the payment information message 205. The payment processing computer 140 can then create and send a payment request message 206 to the appropriate payment entity of the payment entities payment systems 150 associated with the payment information. The payment entities payment systems 150 can perform payment reconciliation according to any known payment reconciliation technique. Once payment is completed between the payment entities (one entity representing the customer, and one entity representing the merchant; or the payment entity can be same for both merchant and customer), the payment entities payment systems 150 can send a payment completed message 207 to the payment processing computer 140. The payment processing computer 140 can then send a payment confirmation message 208 to the order computer 110 (e.g., via the payment module 117). The order computer 110 can be configured to display a payment completion notification to the customer via the display 111 of the order computer 110 (or text, email, or both text and email). In some embodiments, the order computer 110 can be further configured to send a payment confirmation message 209 to the service computer 120. The service computer 120 can be configured to display the payment confirmation message 209, or a notification of receipt of the message 209, via the real-time data connection between the order computer 110 and the service computer 120, on the display 121 of the service computer 120. In aspects, after the payment confirmation message 209 is received by the service computer 120, the service computer 120 can disconnect from the video session 203 and order creation 204 with the order computer 110, so that the service computer 120 can be available to accept another request for an order session.

After receiving the payment confirmation message 208 from the payment processing computer 140, the order computer 110 can be configured to send a customer order message 210 to the fulfillment computer 130. The fulfillment computer 130 is configured to display the order to merchant personnel to fulfill the order and give/deliver/perform the order to/for the customer.

The video surveillance system 160 can be configured to send video surveillance data 202 to the service computer 120. The timing of sending the video surveillance data 202 is not limited by the disclosure, and the data 202 can be sent continuously while the service computer 120 is in order session 220 with the order computer 110.

After sending the order to the fulfillment computer 130, the order computer 110 can be configured to change from the active state to the standby state. In the first seconds of the standby state, the order computer 110 can be configured to display instructions on the display 111, e.g., for the customer to pick up the ordered goods.

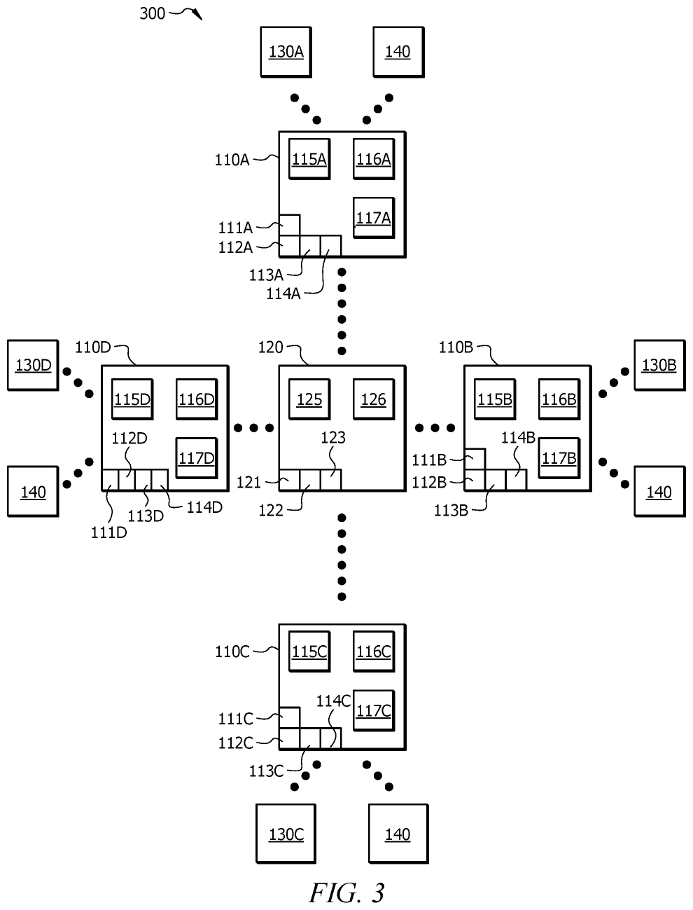

FIG. 3 illustrates a schematic diagram of another embodiment of a contactless ordering and payment computer system 300. The system 300 include one service computer 120 that can connect with any of order computers 110A, 110B, 110C, and 110D to establish the real-time two-way video stream and the real-time data connection that allows human-to-human interaction and order building with a customer service agent that is remote from the customer. While four order computers 110A, 110B, 110C, and 110D are illustrated in FIG. 3, it is contemplated the more or fewer order computers can be included in the system 300.

Order computer 110A has a display 111A, a video camera 112A, a microphone and speaker 113A, a sensor 114A, a video conferencing module 115A, an order module 116A, and a payment module 117A. Order computer 110B has a display 111B, a video camera 112B, a microphone and speaker 113B, a sensor 114B, a video conferencing module 115B, an order module 116B, and a payment module 117B. Order computer 110C has a display 111C, a video camera 112C, a microphone and speaker 113C, a sensor 114C, a video conferencing module 115C, an order module 116C, and a payment module 117C. Order computer 110D has a display 111D, a video camera 112D, a microphone and speaker 113D, a sensor 114D, a video conferencing module 115D, an order module 116D, and a payment module 117D.

For descriptive purposes, order computers 110A, 110B, 110C, and 110D can be at a different geographic locations: order computer 110A is at a first geographic location, order computer 110B is at a second geographic location, order computer 110C is at a third geographic location, and order computer is at a fourth geographic location—where the first geographic location is not the same as the second and third and fourth geographic locations, the second geographic location is not the same as the third and fourth geographic locations, and the third geographic location is not the same as the fourth geographic location.

The geographic location of fulfillment computer 130A can be the same as or different than the geographic location of the order computer 110A; the geographic location of fulfillment computer 1308 can be the same as or different than the geographic location of the order computer 1108; the geographic location of fulfillment computer 130C can be the same as or different than the geographic location of the order computer 110C; the geographic location of fulfillment computer 130D can be the same as or different than the geographic location of the order computer 110D; or combinations thereof.

In embodiments, the service computer 120 can be connected to each of the order computers 110A, 110B, 110C, and 110D for real-time two-way video stream at all times; alternatively, the real-time two-way video stream can be switch off between the service computer 120 and any of order computers 110A, 110B, 110C, and 110D for which no customer is sensed by the sensors 114A, 114B, 114C, and 114D.

In FIG. 3 each order computer 110A, 1108, 110C, and 110D is paired with a fulfillment computer 130A, 130B, 130C, and 130D. FIG. 3 demonstrates all the order computers 110A, 110B, 110C, and 110D of the system 300 can utilize the same payment processing computer 140.

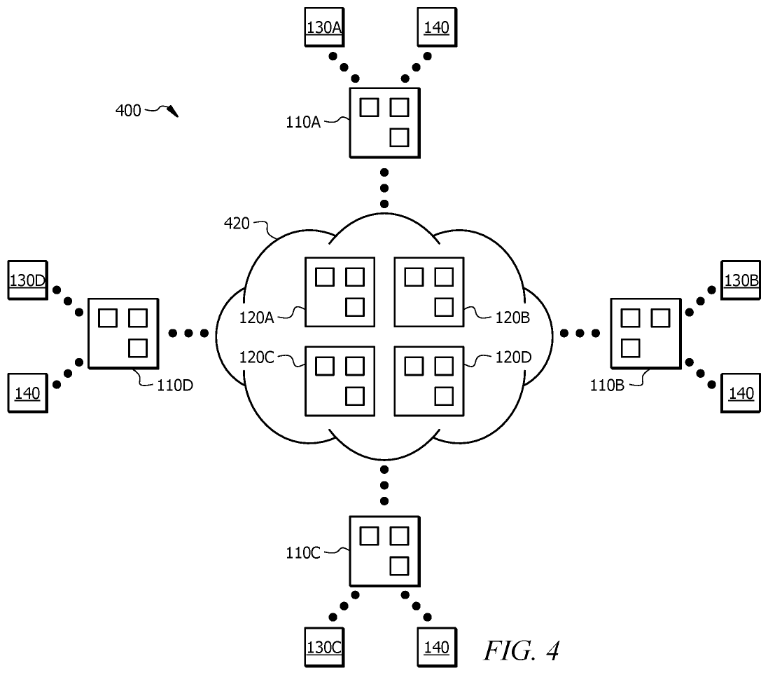

FIG. 4 illustrates a schematic diagram of another embodiment of a contactless ordering and payment computer system 400. The system 400 include multiple service computers 120A, 120B, 120C, and 120D that can be networked with multiple order computers 110A, 110B, 110C, and 110D. While four order computers 110A, 110B, 110C, and 110D are illustrated in FIG. 3, it is contemplated the more or fewer order computers can be included in the system 400. While four service computers 120A, 1208, 120C, and 120D are illustrated in FIG. 4, it is contemplated the more or fewer service computers can be included in the system 400.

Each of the service computers 120A, 120B, 120C, and 120D can each be embodied as described for the service computer 120 in the system 100 of FIG. 1. It is contemplated that service computers 120A, 120B, 120C, and 120D can be embodied as a mixture of smartphones, desktops, laptops, and tablets, for example.

Each of the service computers 120A, 1208, 120C, and 120D can connect with any of the order computers 110A, 110B, 110C, and 110D to accomplish order creation as described hereinabove. Connection can occur as described for order computer 110 and service computer 120 in FIG. 1, FIG. 2, and FIG. 3.

The multiple service computers 120A, 120B, 120C, and 120D can be referred to as a service computer system 420. The service computer system 420 can have a distributed computer architecture, such that hardware is geographically distributed to remotely connect an order computer 110A, 1108, 110C, or 110D in a first geographic location with the service computer 120A, 120B, 120C, or 120D that is geographically closest to the first geographic location of the order computer 110A, 110B, 110C, or 110D. An advantage of distributed architecture is scalability for mass ordering and payment for myriad order computers.

Generally, none of the service computers 120A, 120B, 120C, and 120D are in the same geographic location as any of the order computers 110A, 1108, 110C, and 110D. It is possible in some embodiments that a service computer 120A embodied as an agent's smartphone can be in the same geographic location as an order computer 110A embodied as a customer's smartphone, such as a coffee shop where both the customer service agent and the customer are unwittingly in the same geographic location. In such a coincidental embodiment, the customer and customer service agent can talk through the respective smartphones to generate and pay for the order, and would not talk directly like in traditional brick and mortar locations.

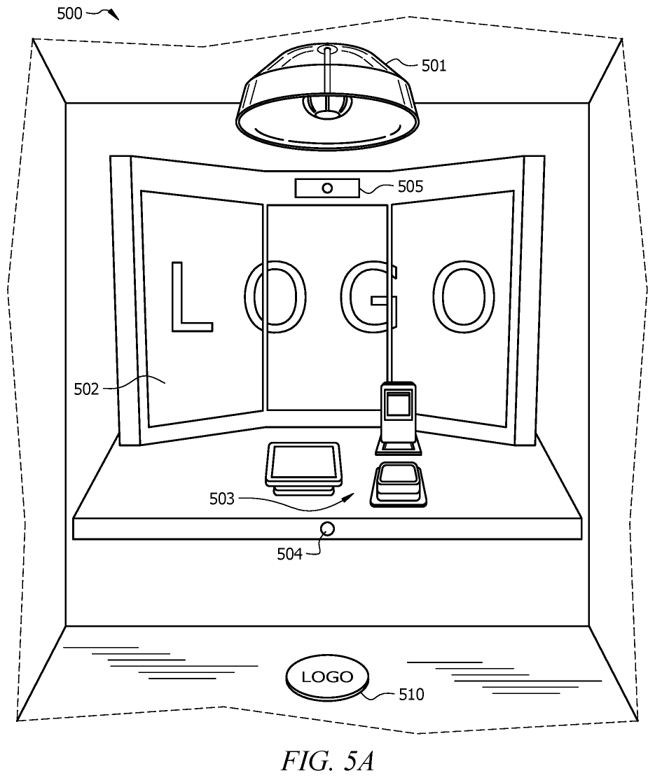

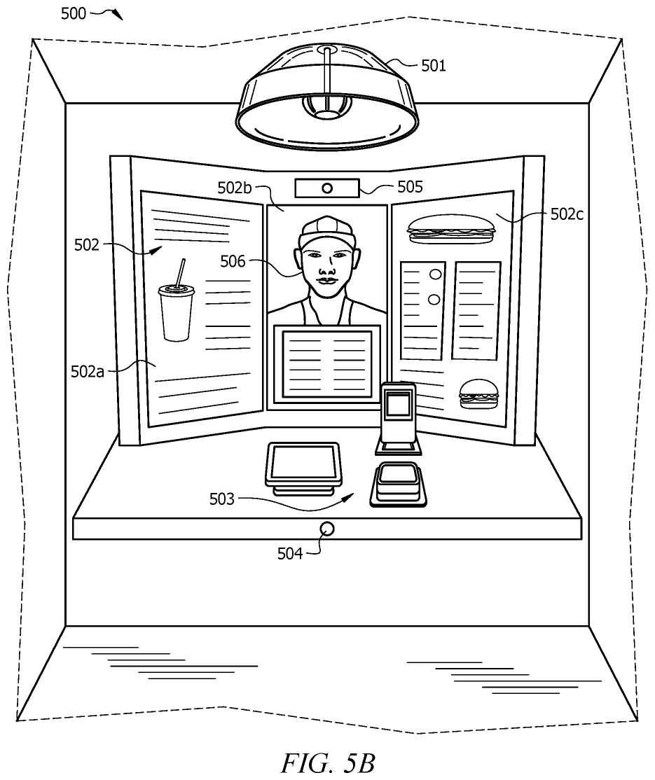

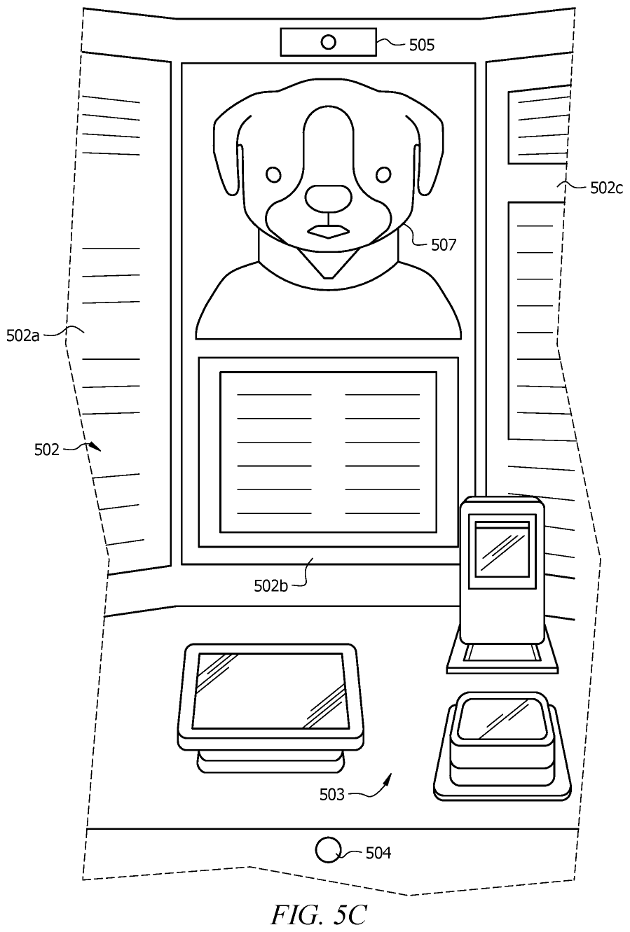

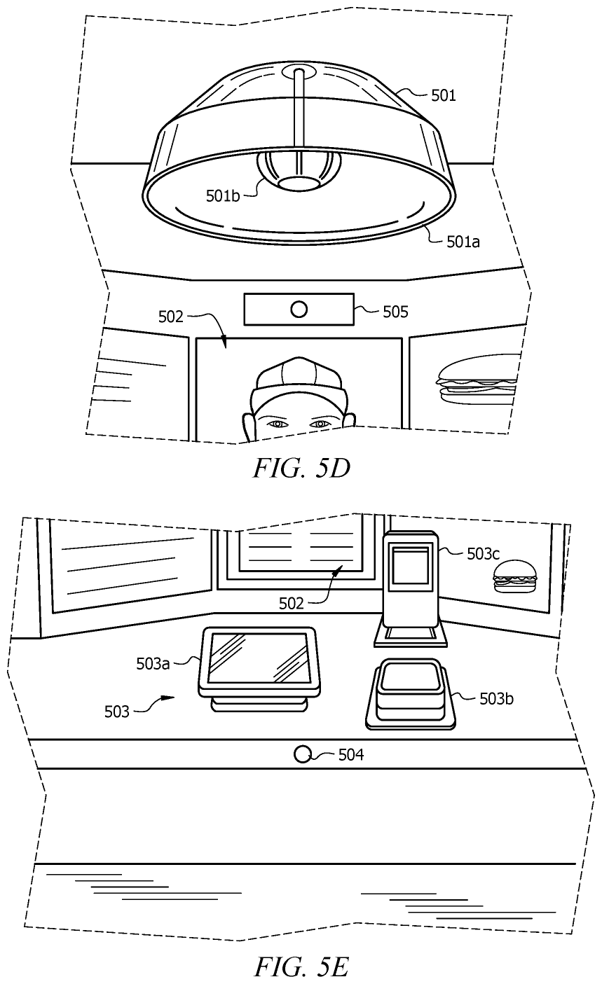

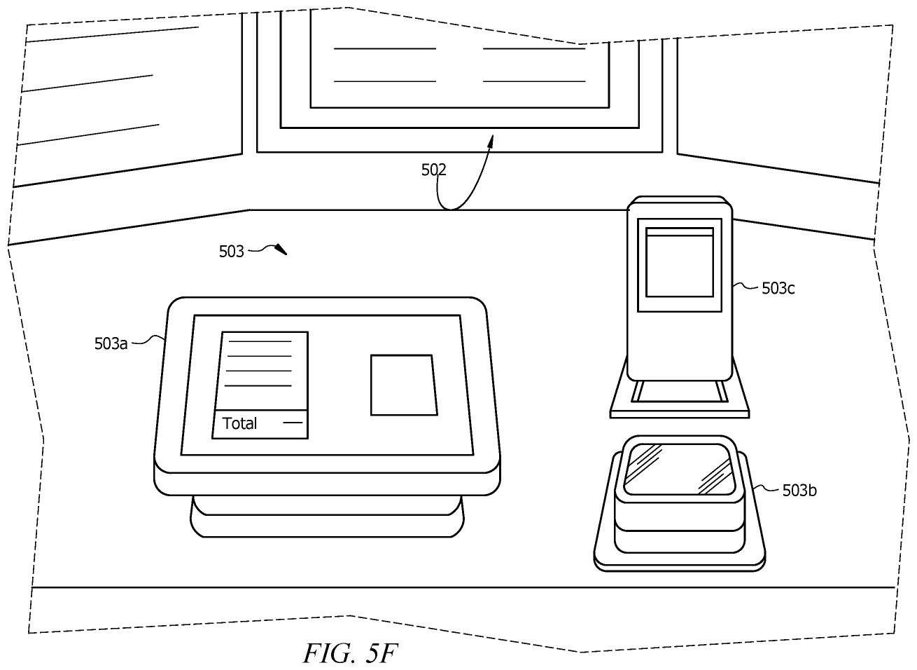

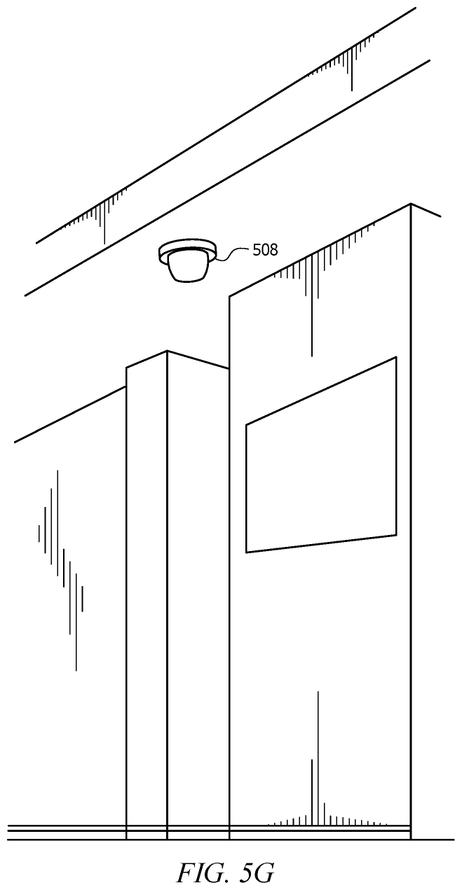

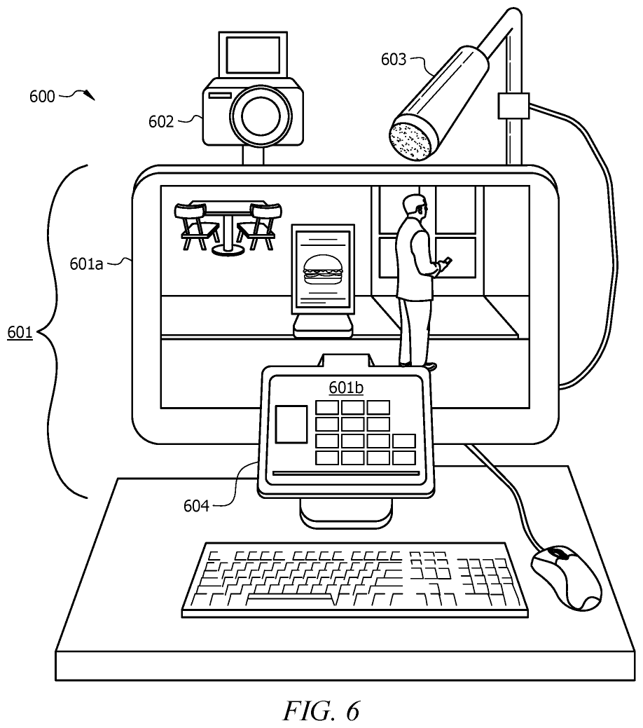

FIGS. 5A to 5G illustrate various perspective views of an order computer embodied as a kiosk 500. FIG. 6 illustrates a perspective view of a service computer 600. Description of the kiosk 500 is made with reference to the service computer 120 described herein or to the service computer 600 of FIG. 6. Description of the service computer 600 is made with reference to the service computer 120 described herein or to the kiosk 500.

FIG. 5A shows the kiosk 500 can include a sound assembly 501 containing a microphone and speaker, a display 502 having three screens, payment hardware 503 including a screen and card reader and code reader, a motion sensor 504 for detecting or sensing the customer presence, and a video camera 505 for viewing the customer in the real-time two-way video stream. FIG. 5A shows the display 502 in a standby state, without a customer present at the kiosk 500. In the standby state, the screens of the display 502 can display any image(s), such as a brand logo, an advertisement, a menu, or combinations thereof.

The kiosk 500 can be changed from the standby state to an active state by sensing presence of a customer via sensor 504. For example, a customer can stand on floor marker 510 placed on the floor next to the display 502 of the kiosk 500 and below the sound assembly 501 such that 1) the sensor 504 senses presence of the customer and 2), the microphone of the sound assembly 501 can detect the customer's voice, and 3) the customer is in viewing range of the display 502 and can hear the sound emitted from speaker of the sound assembly 501.

FIG. 5B shows the kiosk 500 in an activated state after detecting or otherwise sensing a presence of a customer using the sensor 504. In the activated state, the video camera 505 is on, and the sound assembly 501 is on. As can be seen, the images on the display 502 have are different in the active sate compared with the images in FIG. 5A when the kiosk 500 is in the standby state. Screen 502a displays a menu, screen 502b displays the real-time live video stream of the customer service agent from a service computer 120, and screen 502c displays a menu. Image 506 is the actual image of the customer service agent at the service computer 120.

FIG. 5C illustrates the screen 502b of display 502 having an avatar 507 for the customer service agent in the real-time live video stream. The avatar 507 can be any representation of the customer service agent, whether cartoon, representing the likeness of the customer service agent, being unlike the actual likeness of the customer service agent, or a known real or fictional character such as a Disney™ princess or a famous actor. The avatar 507 can be built by the customer service agent and customized to their liking.

FIG. 5D illustrates a close-up perspective view of the sound assembly 501. The sound assembly 501 can include a directional shell 501a and a microphone and speaker 501b. The directional shell 501a can be configured to direct sound waves emitted by the speaker of the microphone and speaker 501b substantially vertically downward toward the customer. In a room having loud background noise, the directional shell 501a creates a sound zone where the customer can hear the directional sound waves louder than the background noise. Similarly, the directional shell 501a can capture customer voice sound waves and direct the voice sound waves to the microphone in the microphone and speaker 501b. The microphone and speaker of the microphone and speaker 501b can be integrated into the same physical casing or shell, or can be separate devices.

FIG. 5E and FIG. 5F illustrate close-up perspective views of payment hardware 503 of the kiosk 500. It can be seen that the payment hardware 503 can include a payment display 503a, a card reader 503b, and a code scanner 503c. The payment display 503a is embodied as a tablet that can be networked with the service computer 120 and configured to display the order that is entered by the customer service agent at the service computer 120 during a real-time two-way video session and via the real-time data connection that is between the kiosk 500 and the service computer 120. One or more of the video conferencing module, the order module, and the payment module of the kiosk 500 can run on the tablet that contains the payment display 503a; alternatively, one or more of the video conferencing module, the order module, and the payment module of the kiosk 500 can run on a computer that is located below the payment hardware 203 or behind the display 502, for example. The display 503a can be networked to service computer 120, to the fulfillment computer 130 and to one or more of the card reader 503b, the code scanner 503c, and the payment processing computer 140. The display 503a can be configured to receive payment confirmation from one or more of the card reader 503b, the code scanner 503c, and to send the payment information (e.g., via a payment module) to the payment processing computer 140. In additional aspects, the display 503a can be configured to send the order (e.g., via the order module on the display 503a) to the fulfillment computer 130. Alternatively, the card reader 503b and code scanner 503c can include the payment module of the kiosk 500 and can be networked with the payment processing computer 140 and configured to transmit the payment information obtained by scanning or input at reader 503b or scanner 503c to the payment processing computer 140. The card reader 503b and code scanner 503c can additionally be configured to receive payment confirmation from the payment processing computer 140 (e.g., via the payment module). In these aspects, the card reader 503b and code scanner 503c can send the payment confirmation to the display 503a, and the display 503a, via the order module, can send the payment confirmation to the service computer 120 via the real-time data connection.

FIG. 5G illustrates a perspective view of a video camera 508 that can be part of a video surveillance system 160. The camera 508 is configured to send video images of the kiosk 500 to the service computer 120 or other computer for data analysis and recordation. For example, data can be analyzed for determining customer density at the kiosk 500 over time and other customer data that can be extracted from video images.

Embodiments of this disclosure contemplate that the kiosk 500 can be a virtual kiosk in a metaverse environment, where a customer can virtually access the kiosk via customer metaverse equipment, the kiosk can be activated from a standby state to an active state, the customer viewing the virtual kiosk in the metaverse and customer service agent at a physical real service computer 120 can interact via the real-time two-way video stream and a real-time data connection that are established between the metaverse device used by the customer (an embodiment of an order computer) and the service computer 120 or 600.

FIG. 6 illustrate a perspective view of a service computer 600. The service computer 600 can include a display 601, a video camera 602, a microphone 603, and a speaker 604. The display 601 includes a first screen 601a configured to display the real-time two-way video session 203 and a second screen 601b configured to display the order built during order creation 204 (e.g., images associated with building an order on the service computer 120 via the real-time data connection between the service computer 600 and the kiosk 500). The video camera 602 is configured for viewing the customer service agent in the real-time two-way video stream. The microphone 603 is configured to sense the human voice of the customer service agent during the real-time two-way video stream. The speaker 604 is integrated in a tablet that has the second screen 601b (a touchscreen for inputting the order by the customer service agent), and the speaker 604 is configured to emit the sounds waves that correspond to the digital signal representing the customer's voice that is received from the order computer 110 (or kiosk 500). The tablet can run the video conferencing module and the order module of the service computer 600; alternatively, another computer can be utilized in the service computer 600 to run the video conference module while the tablet runs the order module.

Embodiments disclosed herein contemplate that a customer's spoken language can be detected by the microphone of the order computer, and the order computer, the service computer, or both can be configured to connect the order computer with a service computer having a customer service agent that speaks the same language as the customer.

Embodiment disclosed herein further contemplate integration with a merchant's loyalty program. For example, the code scanner can be configured to scan the customer loyalty code and be networked with a loyalty server that tracks customer loyalty points and that communicates with the service computer to offer discounts or other rewards to the customer while the customer is at the order computer.

### Additional Description

The present application is also directed to the subject-matter described in the following numbered clauses:

Clause 1. A method comprising: receiving, by a service computer from an order computer, a real-time connection request; and in response to receiving the real-time connection request, connecting, by the service computer and the order computer, for an order session, wherein connecting comprises: joining, by the service computer, a real-time two-way video stream between a video conferencing module of the order computer and a video conferencing module of the service computer, and joining, by the service computer, a real-time one-way data connection between an order module of the order computer and an order module of the service computer, wherein the service computer and the order computer are connected to the real-time two-way video stream and the real-time one-way data connection simultaneously.

Clause 2. The method of clause 1, wherein the order session comprises a video session and an order creation, wherein the video session is conducted over the real-time two-way video stream, wherein the order creation is conducted over the real-time one-way data connection.

Clause 3. The method of clause 1 or 2, wherein the service computer comprises a first screen configured to display the video session and a second screen configured to display an order that is built during the order creation.

Clause 4. The method of any one of clauses 1 to 3, further comprising: transmitting, by the service computer to the order computer via the real-time one-way data connection, the order for display on a display of the order computer.

Clause 5. The method of any one of clauses 1 to 4, further comprising: receiving, by the service computer from the order computer, a payment confirmation message; displaying, by the service computer, the payment confirmation message on the second screen of the order computer; and disconnecting, by the service computer, from the real-time two-way video stream and the real-time one-way data connection.

Clause 6. The method of any of clauses 1 to 5, wherein an order is built during the order creation, the method further comprising: displaying, by the order computer, a prompt on a display of the order computer requesting input of payment information at the order computer; receiving, by a payment module of the order computer, payment information from a customer; interacting, by the payment module of the order computer, with a payment provider computer to process a payment for the order; and receiving, by the order computer from the payment provider computer, a payment confirmation.

Clause 7. The method of any one of clauses 1 to 6, further comprising: sending, by the order module of the order computer, the order to an order fulfillment computer.

Clause 8. The method of any one of clauses 1 to 7, further comprising; sending, by the payment module of the order computer, a payment confirmation message to the service computer.

Clause 9. The method of any one of clauses 1 to 8, wherein the order computer is a kiosk comprising a display having one or more screens, a video camera, a sound assembly, a sensor, and payment hardware.

Clause 10. The method of any one of clauses 1 to 10, wherein the order computer is a smartphone having an application running thereon that contains the video conferencing module and the order module of the order computer.

Clause 11. A service computer having a processor, a memory, and instructions stored on the memory that are configured to be executed by the processor to cause the service computer to: receive, from an order computer, a real-time connection request; and in response to receiving the real-time connection request, connect with the order computer for an order session, wherein connect comprises: join a real-time two-way video stream between a video conferencing module of the order computer and a video conferencing module of the service computer, and join a real-time one-way data connection between an order module of the order computer and an order module of the service computer, wherein the service computer and the order computer are connected to the real-time two-way video stream and the real-time one-way data connection simultaneously.

Clause 12. The service computer of clause 11, wherein the order session comprises a video session and an order creation, wherein the video session is conducted over the real-time two-way video stream, wherein the order creation is conducted over the real-time one-way data connection.

Clause 13. The service computer of clause 12, comprising a first screen configured to display the video session and a second screen configured to display an order that is built during the order creation.

Clause 14. The service computer of clause 13, wherein the instructions executed by the processor further cause the service computer to: transmit to the order computer via the real-time one-way data connection, the order for display on a display of the order computer.

Clause 15. The service computer of clause 14, wherein the instructions executed by the processor further cause the service computer to: receive from the order computer a payment confirmation message; display the payment confirmation message on the second screen of the order computer; and disconnect from the real-time two-way video stream and the real-time one-way data connection.

Clause 16. A method comprising: sending, by an order computer to a service computer, a real-time connection request; and in response to sending the real-time connection request, connecting, by the service computer and the order computer, for an order session, wherein connecting comprises: joining, by the order computer, a real-time two-way video stream between a video conferencing module of the order computer and a video conferencing module of the service computer, and joining, by the order computer, a real-time one-way data connection between an order module of the order computer and an order module of the service computer, wherein the service computer and the order computer are connected to the real-time two-way video stream and the real-time one-way data connection simultaneously.

Clause 17. The method of clause 16, wherein the order session comprises a video session and an order creation, wherein the video session is conducted over the real-time two-way video stream, wherein the order creation is conducted over the real-time one-way data connection.

Clause 18. The method of clause 16 or 17, further comprising: receiving, by the order computer from the service computer via the real-time one-way data connection, an order built during the order session; and displaying, by the order computer, the order on a display of the order computer in real-time.

Clause 19. The method of any one of clauses 16 to 18, further comprising: displaying, by the order computer, a prompt on a display of the order computer requesting input of payment information at the order computer; receiving, by a payment module of the order computer, payment information from a customer; interacting, by the payment module of the order computer, with a payment provider computer to process a payment for the order; and receiving, by the order computer from the payment provider computer, a payment confirmation.

Clause 20. The method of any one of clauses 16 to 19, further comprising: sending, by the order module of the order computer, the order to an order fulfillment computer; and sending, by the payment module of the order computer, a payment confirmation message to the service computer.

Clause 21. An order computer having a processor, a memory, and instructions stored on the memory that are configured to be executed by the processor to cause the order computer to: send to a service computer a real-time connection request; and in response to send the real-time connection request, connect, by the service computer and the order computer, for an order session, wherein connect includes: join, by the order computer, a real-time two-way video stream between a video conferencing module of the order computer and a video conferencing module of the service computer, and join, by the order computer, a real-time one-way data connection between an order module of the order computer and an order module of the service computer, wherein the service computer and the order computer are connected to the real-time two-way video stream and the real-time one-way data connection simultaneously.

Clause 22. The order computer of clause 21, wherein the order session comprises a video session and an order creation, wherein the video session is conducted over the real-time two-way video stream, wherein the order creation is conducted over the real-time one-way data connection.

Clause 22. The order computer of clause 20 or 21, wherein the instructions executed by the processor further cause the order computer to: receiving, by the order computer from the service computer via the real-time one-way data connection, an order built during the order session; and display, by the order computer, the order on a display of the order computer in real-time.

Clause 23. The order computer of any one of clauses 20 to 22, wherein the instructions executed by the processor further cause the order computer to: display a prompt on a display of the order computer requesting input of payment information at the order computer; receive, by a payment module of the order computer, payment information from a customer; interact, by the payment module of the order computer, with a payment provider computer to process a payment for the order; and receive, by the order computer from the payment provider computer, a payment confirmation.

Clause 24. The order computer of any one of clauses 20 to 23, wherein the instructions executed by the processor further cause the order computer to: send, by the order module of the order computer, the order to an order fulfillment computer; and send, by the payment module of the order computer, a payment confirmation message to the service computer.

Clause 25: A service and order computer system comprising: one or more services computers capable of being networked with one or more order computers, wherein each of the service computers has a video conferencing module and an order module that are capable of, upon request from any of the order computers, connecting with a video conference module and an order module of the respective order computer, wherein connecting includes joining, by a service computer/order computer pair, a real-time two-way video stream between a video conferencing module of the order computer and a video conferencing module of the service computer, and joining, by the service computer/order computer pair, a real-time one-way data connection between an order module of the order computer and an order module of the service computer, wherein the service computer/order computer pair are connected to the real-time two-way video stream and the real-time one-way data connection simultaneously. The one or more service computers can each independently be embodied according to any embodiment described herein. The one or more order computers can each independently be embodied according to any embodiment described herein. The system can also include a video surveillance system configured to record and/or a video of the order computer and area for a customer ordering at the order computer to a server for video surveillance. The system can also include one or more fulfillment computers networked with the one or more order computers, wherein each fulfillment computer is configured to receive an order from the respective order computer after order competition using the connections between the service computer/order computer pair.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method comprising:
receiving, by a service computer from an order computer, a real-time connection request; and
in response to receiving the real-time connection request, connecting, by the service computer and the order computer, for an order session, wherein connecting comprises:
joining, by the service computer, a real-time two-way video stream between a video conferencing module of the order computer and a video conferencing module of the service computer, and
joining, by the service computer, a real-time one-way data connection between an order module of the order computer and an order module of the service computer,
wherein the service computer and the order computer are connected to the real-time two-way video stream and the real-time one-way data connection simultaneously.

2. The method of claim 1, wherein the order session comprises a video session and an order creation, wherein the video session is conducted over the real-time two-way video stream, wherein the order creation is conducted over the real-time one-way data connection.

3. The method of claim 2, wherein the service computer comprises a first screen configured to display the video session and a second screen configured to display an order that is built during the order creation.

4. The method of claim 3, further comprising:
transmitting, by the service computer to the order computer via the real-time one-way data connection, the order for display on a display of the order computer.

5. The method of claim 4, further comprising:
receiving, by the service computer from the order computer, a payment confirmation message;
displaying, by the service computer, the payment confirmation message on the second screen of the order computer; and
disconnecting, by the service computer, from the real-time two-way video stream and the real-time one-way data connection.

6. The method of claim 2, wherein an order is built during the order creation, the method further comprising:
displaying, by the order computer, a prompt on a display of the order computer requesting input of payment information at the order computer;
receiving, by a payment module of the order computer, payment information from a customer;
interacting, by the payment module of the order computer, with a payment provider computer to process a payment for the order; and
receiving, by the order computer from the payment provider computer, a payment confirmation.

7. The method of claim 6, further comprising:
sending, by the order module of the order computer, the order to an order fulfillment computer.

8. The method of claim 6, further comprising;
sending, by the payment module of the order computer, a payment confirmation message to the service computer.

9. The method of claim 1, wherein the order computer is a kiosk comprising a display having one or more screens, a video camera, a sound assembly, a sensor, and payment hardware.

10. The method of claim 1, wherein the order computer is a smartphone having an application running thereon that contains the video conferencing module and the order module of the order computer.

11. A service computer having a processor, a memory, and instructions stored on the memory that are configured to be executed by the processor to cause the service computer to:
receive, from an order computer, a real-time connection request; and
in response to receiving the real-time connection request, connect with the order computer for an order session, wherein connect comprises:
join a real-time two-way video stream between a video conferencing module of the order computer and a video conferencing module of the service computer, and
join a real-time one-way data connection between an order module of the order computer and an order module of the service computer,
wherein the service computer and the order computer are connected to the real-time two-way video stream and the real-time one-way data connection simultaneously.

12. The service computer of claim 11, wherein the order session comprises a video session and an order creation, wherein the video session is conducted over the real-time two-way video stream, wherein the order creation is conducted over the real-time one-way data connection.

13. The service computer of claim 12, comprising a first screen configured to display the video session and a second screen configured to display an order that is built during the order creation.

14. The service computer of claim 13, wherein the instructions executed by the processor further cause the service computer to:
transmit to the order computer via the real-time one-way data connection, the order for display on a display of the order computer.

15. The service computer of claim 14, wherein the instructions executed by the processor further cause the service computer to:
receive from the order computer a payment confirmation message;
display the payment confirmation message on the second screen of the order computer; and
disconnect from the real-time two-way video stream and the real-time one-way data connection.

16. A method comprising:
sending, by an order computer to a service computer, a real-time connection request; and
in response to sending the real-time connection request, connecting, by the service computer and the order computer, for an order session, wherein connecting comprises:
joining, by the order computer, a real-time two-way video stream between a video conferencing module of the order computer and a video conferencing module of the service computer, and
joining, by the order computer, a real-time one-way data connection between an order module of the order computer and an order module of the service computer,
wherein the service computer and the order computer are connected to the real-time two-way video stream and the real-time one-way data connection simultaneously.

17. The method of claim 16, wherein the order session comprises a video session and an order creation, wherein the video session is conducted over the real-time two-way video stream, wherein the order creation is conducted over the real-time one-way data connection.

18. The method of claim 16, further comprising:
receiving, by the order computer to the service computer via the real-time one-way data connection, an order built during the order session; and
displaying, by the order computer, the order on a display of the order computer in real-time.

19. The method of claim 18, further comprising:
displaying, by the order computer, a prompt on a display of the order computer requesting input of payment information at the order computer;
receiving, by a payment module of the order computer, payment information from a customer;
interacting, by the payment module of the order computer, with a payment provider computer to process a payment for the order; and
receiving, by the order computer from the payment provider computer, a payment confirmation.

20. The method of claim 19, further comprising:
sending, by the order module of the order computer, the order to an order fulfillment computer; and
sending, by the payment module of the order computer, a payment confirmation message to the service computer.
